(19) United States
(12) Patent Application Publication
(10) Pub. No.: US 2006/0071186 A1
(43) Pub. Date: Apr. 6, 2006

(54) Image readout apparatus

(75) Inventor: Akira Yamaguchi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,340

(22) Filed: Sep. 30, 2005

(30) Foreign Application Priority Data
Oct. 1, 2004 (JP) 2004-289816

(51) Int. Cl. G03B 42/08

(52) U.S. Cl. 250/584

(57) ABSTRACT

An image readout apparatus capable of reliably eliminating residual image information remaining on the image recording medium after the image information has been read out from the medium. Linear light is irradiated on the image recording medium from the readout light source constituted by a plurality of electroluminescence elements arranged in stripes, and erasing light for erasing image information recorded on the image recording medium is irradiated on the medium from the erasing light source through the gaps between the electroluminescence elements.

### BACKGROUND OF THE INVENTION

1. Field of the Invention

The present invention relates to an image readout apparatus for reading out image information recorded on an image recording medium by irradiating linear light on the recording medium using electroluminescence elements.

2. Description of the Related Art

In the field of medical X-ray imaging, solid-state detectors are proposed in order to reduce an amount of dosage exposed to a subject, and to improve diagnostic capabilities. Such detector uses a photoconductor, such as an X-ray-sensitive selenium plate made of, for example, a-Se as an electrostatic recording medium, and radiation, such as X-ray, that carries radiation image information is irradiated on the electrostatic recording medium to record the image information on the recording medium. In addition, storage phosphor sheets that record image information and produce photostimulable luminescence in accordance with the image information when scan exposed to readout light are also known.

An image readout unit having an image recording medium and a scan exposing device integrally formed as a unit is known as described, for example, in Japanese Unexamined Patent Publication No. 2004-156908. It is formed by stacking a readout light irradiating section for scan exposing readout light as a layer on top of an image recording medium, such as the solid-state detector or the storage phosphor sheet described above. As the scan exposing device, a panel light source is used, which includes a plurality of optically transparent linear electrodes arranged in stripes, a back plate made of a flat metal, and an electroluminescence layer (EL layer) provided between the linear electrodes and back plate. In the scan exposing device, a driving voltage is applied sequentially to each of the linear electrodes, and the portion of the EL layer corresponding to the linear electrode to which the driving voltage is applied produces luminescence, which is used as the linear scanning light.

In the mean time, charges representing image information may remain on the image recording medium after the image information has been read out, and the residual charges may affect the subsequent image taking. As such, a method for erasing the charges remaining on the image recording medium is known, in which the residual charges are erased by re-irradiating the readout light thereon.

Where a panel light source is used, however, the readout light is emitted only from the regions of the light source where the linear electrodes are formed, so that the readout light is not irradiated on the gap regions of the image recording medium corresponding to the gaps between the linear electrodes. Consequently, the charges representing image information remain continually on the gap regions of the image recording medium where the readout light is not irradiated by the readout light. If a next image is obtained using such image recording medium, a problem may arise that the image quality is degraded due to the residual charges.

### SUMMARY OF THE INVENTION

Therefore, it is an object of the present invention to provide an image readout apparatus capable of reliably eliminating image information remaining on the image recording medium after the image information has been read out from the medium.

The image readout apparatus of the present invention is an image readout apparatus for reading out image information recorded on an image recording medium by irradiating readout light thereon, the apparatus comprising:

a readout light source constituted by a plurality of electroluminescence elements arranged in stripes for irradiating linear light on the image recording medium; and

an erasing light source for emitting erasing light through gaps between the electroluminescence elements to erase image information recorded on the image recording medium.

Here, the erasing light source may be any light source as long as it is capable of irradiating the erasing light on the gap regions of the image recording medium where the readout light is not irradiated by emitting the erasing light through the gaps between the electroluminescence elements of the readout light source.

The electroluminescence element may be made of an inorganic or organic electroluminescence material.

Further, the erasing light source may be any light source as long as it is capable of emitting the erasing light. It may be constructed using electroluminescence elements or a cold cathode ray tube. When the erasing light source is constituted by electroluminescence elements, the readout light source may be constituted by electroluminescence elements layered on a first surface of a transparent substrate, and the erasing light source may be constituted by electroluminescence elements layered on a second surface of the substrate.

Still further, the erasing light source may have any structure as long as it is capable of irradiating the erasing light on the gap regions where the readout light is not irradiated by the readout light source. It may be structured such that it irradiates erasing light only on the gap regions of the image recording medium through the gaps between the electroluminescence elements of the readout light source, or on the regions of the image recording medium including the regions where the readout light is irradiated, as well as the gap regions. In the latter case, the erasing light source is formed such that it overlaps with the region where the readout light source is formed. That is, the electroluminescence elements of the readout light source and electroluminescence elements of the erasing light source are formed such that each of the regions where the electroluminescence element of the erasing light source is formed overlaps with the regions on the opposite side of the substrate where the electroluminescence elements of the readout light source are formed.

A focusing optics system for focusing readout light may be disposed between the image recording medium and readout light source.

Further, a drive control means for controlling the operation of the readout light source and erasing light source may further be provided. The drive control means may be configured to control the readout light source and erasing light source such that only the erasing light is emitted, or the erasing light is emitted from the erasing light source and the readout light is emitted from the readout light source, when erasing image information recorded on the image recording medium.

According to the image readout apparatus of the present invention, an erasing light source is provided, which emits erasing light for erasing image information recorded on the image recording medium through the gaps between the electroluminescence elements. This allows the erasing light to be irradiated on the gap regions of the image recording medium where readout light is not irradiated, after image information has been read out from the medium by irradiating the readout light thereon. This ensures that image information remaining on the image recording medium is eliminated reliably, thereby degradation in the image quality may be prevented.

Where the panel light source is constructed such that the readout light source is constituted by electroluminescence elements provided on a first surface of a transparent substrate, and erasing light source is constituted by electroluminescence elements provided on a second surface of the substrate, then the readout light source and erasing light source may be formed on a single substrate, thereby a smaller and thinner image readout apparatus may be realized.

Further, by providing the erasing light source with stripe electroluminescence elements arranged at places corresponding to the respective gaps of the striped readout light source, the erasing light may be irradiated on the regions of the image recording medium where the readout light is not irradiated. This ensures that image information remaining on the image recording medium is eliminated reliably.

If the erasing light source is formed such that it overlaps with the region where the readout light source is formed, then the erasing light may be irradiated on the regions of the image recording medium where the readout light is not irradiated, so that image information remaining on the image recording medium may be eliminated reliably.

Further, if a focusing optics system for focusing readout light is disposed between the image recording medium and readout light source, the readout light may be irradiated effectively on the image recording medium.

If the erasing light source is constituted by a cold cathode ray tube, the amount of light to be irradiated on the image recording medium may be increased.

If a drive control means for controlling the readout light source and erasing light source is further provided, and if the erasing light source and readout light source are controlled by the drive control means such that the erasing light is emitted from the erasing light source and readout light is emitted from the readout light source, when erasing image information recorded on the image recording medium, residual image information may be eliminated reliably from the entire region of the image recording medium.

### BRIEF DESCRIPTION OF THE DRAWINGS

FIG. 1 is a structural diagram of a preferred embodiment of the image readout apparatus of the present invention.

FIG. 2 is a schematic diagram of an example panel light source of the image readout apparatus shown in FIG. 1.

FIG. 3 is a schematic diagram of an example drive control unit of the image readout apparatus of the present invention.

FIG. 4 is a schematic diagram of a second embodiment of the panel light source of the present invention.

FIG. 5A is a schematic diagram of a third embodiment of the panel light source of the present invention.

FIG. 5B is a schematic diagram of a third embodiment of the panel light source of the present invention.

FIG. 6 is a schematic diagram of another embodiment of the erasing light source of the present invention.

### DESCRIPTION OF THE PREFERRED EMBODIMENTS

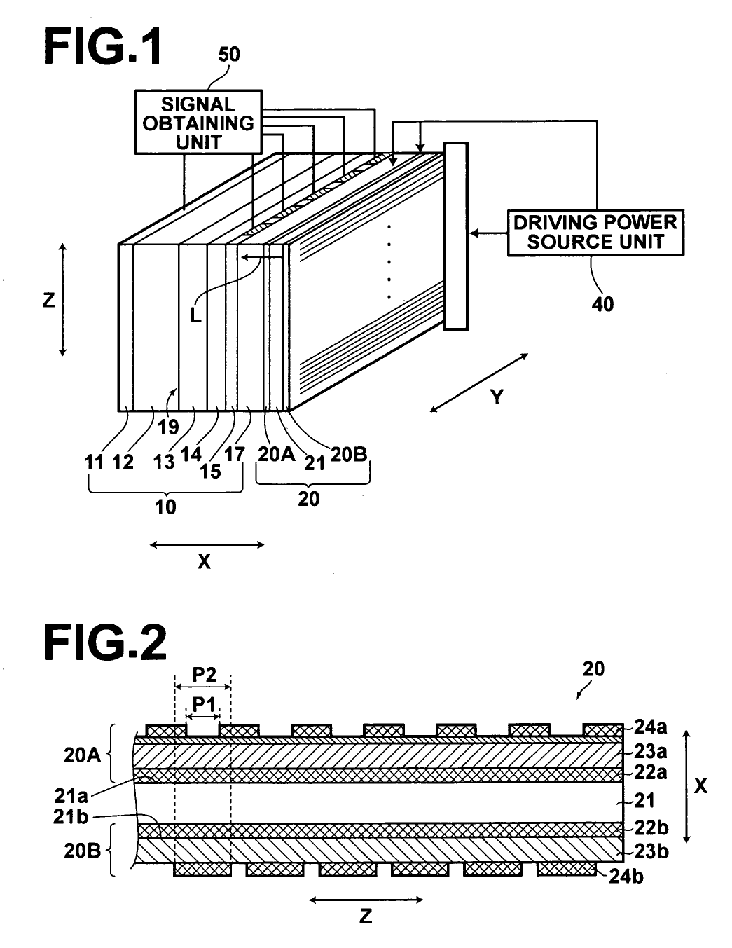

Hereinafter, embodiments of the image readout apparatus of the present invention will be described with reference to the accompanying drawings. FIG. 1 is a schematic structural diagram of the image readout apparatus according to a preferred embodiment of the present invention. The image readout apparatus 1 is a device for reading out image information recorded on an image recording medium by irradiating readout light thereon.

The image recording medium 10 will be described first with reference to FIG. 1. The image recording medium 10 is a so-called optical readout type image recording medium as described, for example, in Japanese Unexamined Patent Publication No. 2000-284056. It includes a readout electrode 11, a readout photoconductive layer 12, a charge transport layer 13, a recording photoconductive layer 14, and a second electrode 15 layered on top of another.

The readout electrode 11 is made of, for example, NESA film or the like, and includes a plurality of linear electrodes extending substantially in parallel with each other in the direction of arrow Y. The linear electrodes are electrically insulated from each other. The readout photoconductive layer 12 is made of, for example, amorphous selenium. The readout photoconductive layer 12 exhibits conductivity when irradiated by readout light and produces charge pairs. The charge transport layer 13 is stacked as a layer on the readout photoconductive layer 12. The charge transport layer 13 acts substantially as an insulator with respect to negative charges, and acts substantially as a conductor with respect to positive charges. The recording photoconductive layer 14 is made of, for example, amorphous selenium. The recording photoconductive layer 14 exhibits conductivity when irradiated by recording electromagnetic waves (light or radiation), and produces charge pairs. Further, the second electrode layer 15, which comprises a plurality of linear electrodes extending in the direction of arrow Z, is stacked as a layer on the recording photoconductive layer 14. The linear electrodes of the second electrode layer 15 are made of a material that transmits the recording electromagnetic waves, such as ITO (Indium Tin Oxide) film.

Here, a charge storage section 19 is formed at the interface between the charge transport layer 13 and the recording photoconductive layer 14. That is, electrons produced in the recording photoconductive layer 14 move toward the readout electrode layer 11 due to the electric field formed between the readout electrode 11 and the second electrode 15. At this time, the movement of the electrons is restricted by the charge transport layer 13. Accordingly, charges corresponding to the amount of irradiated recording electromagnetic waves are stored as an electrostatic latent image. In this way, the image information is recorded on the image recording medium 10.

Here, when image information is recorded on the image recording medium 10, high voltage is applied between the readout electrode 11 and the second electrode 15 from a signal obtaining unit 50. Thereby, the readout electrode 11 is charged with negative charges, and the second electrode 15 is charged with positive charges. Next, recording electromagnetic waves are irradiated from the side of the second electrode 15, causing positive/negative charge pairs to be produced within the recording photoconductive layer 14. Of the charge pairs, positive holes move toward the second electrode 15, couple with the negative charges thereat and disappear. Meanwhile, electrons of the charge pairs move toward the readout electrode 11, but are restricted in their movement by the charge transport layer 13. Thereby, image information is recorded as an electrostatic latent image in the charge storage section 19.

When the image information recorded in the charge storage section 19 is to be read out, linear readout light extending in the direction of arrow Y is emitted from a panel light source 20, which is scanned in the direction of arrow Z. Thereby, charge pairs corresponding to the amount of irradiated readout light are produced in the readout photoconductive layer 12. Positive holes of the charge pairs pass through the charge transport layer 13, couple with the negative charges stored in the charge storage section 19, and disappear. Meanwhile, electrons of the charge pairs move toward the readout electrode 11 to couple with the positive charges thereat. Current flows through the readout electrode 11, when the positive holes and the negative charges couple thereat. The image information is read out by the signal obtaining unit 50 detecting these changes in current.

FIG. 2 is a cross-sectional view of a preferred embodiment of the panel light source 20 of the image readout apparatus 1 shown in FIG. 1. The panel light source 20 will be described with reference to FIGS. 1 and 2. The panel light source 20 includes a readout light source 20A, which is constituted by a plurality of electroluminescence elements arranged in stripes, for emitting linear light on the image recording medium 10, and an erasing light source 20B for emitting erasing light through gaps between the electroluminescence elements to erase image information recorded on the image recording medium 10.

The readout light source 20A is constituted by organic or inorganic EL elements formed on a first surface 21a of an optically transparent substrate 21, such as a glass substrate or the like. The erasing light source 20B is constituted by organic or inorganic EL elements formed on a second surface 21b of the transparent substrate 21. More specifically, the readout light source 20A includes an anode 22a, cathodes 24a, and an El layer layered in the thickness direction therebetween on the first surface 21a. The anode 22a is an optically transparent conductive layer made of, for example, ITO film or the like in a plate shape on the transparent substrate 21. Meanwhile, the cathode 24a is a linear electrode of an optically transparent conductive layer made of, for example, ITO film or the like, and a plurality of the cathodes 24a is arranged in stripes. An EL element for emitting readout light is formed by the anode 22a, cathode 24a, and EL layer 23b sandwiched therebetween, and a plurality of EL elements is arranged in stripes to form the readout light source 20A.

Likewise, the erasing light source 20B includes an anode 22b, cathodes 24b, and an EL layer 23b layered in the thickness direction therebetween on the second surface 21b of the transparent substrate 21. The erasing light source 20B is arranged such that it irradiates erasing light on the image recording medium 10 through the transparent substrate 21. The anode 22b is an optically transparent conductive layer made of, for example, ITO film or the like in a plate shape on the transparent substrate 21. Meanwhile, the cathode 24b is a linear electrode of an optically transparent conductive layer made of, for example, ITO film or the like, and a plurality of the cathodes 24b is arranged in stripes. An EL element for emitting erasing light is formed by the anode 22b, cathode 24b, and EL layer 23b sandwiched therebetween, and a plurality of EL elements is arranged in stripes to form the erasing light source 20B.

Here, each of the cathodes 24b of the erasing light source 20B is formed at the place corresponding to each of the gaps between the cathodes 24a of the readout light source 20A, and arranged such that it emits erasing light through the gap. In particular, each of the cathodes 24b of the erasing light source 20B is formed such that the width P2 thereof is greater than the gap P1 between the cathodes 24a of the readout light source 20A. In addition, the erasing light source 20B is provided such that it overlaps with the region where the readout light source 20A is formed. This ensures that the respective EL elements of the readout light source 20A are invariably located at places corresponding to the respective gaps between the striped EL elements of the erasing light source 20B, so that the entire region of the image recording medium 10 may be irradiated by the readout light or erasing light.

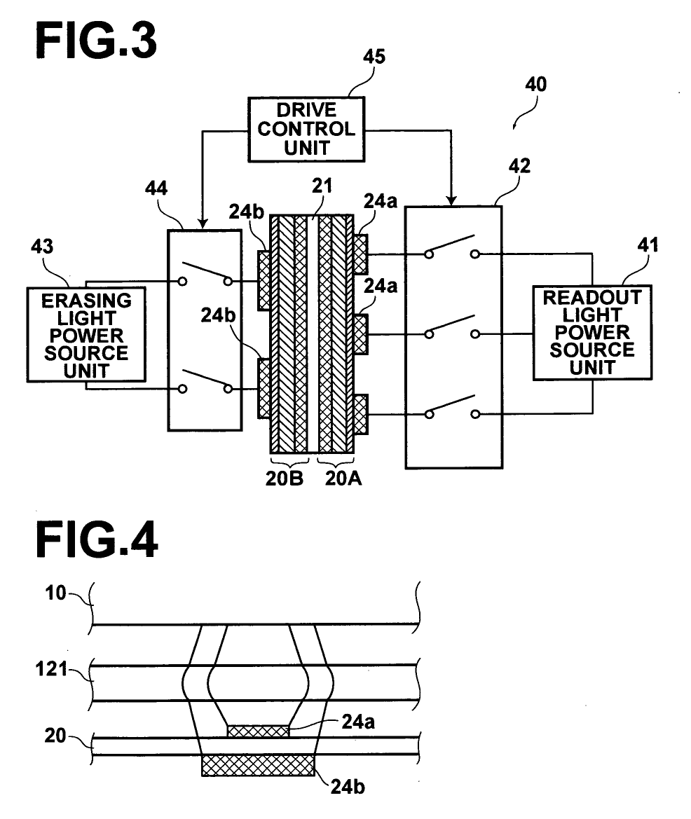

Next, a driving power source unit 40 for causing the panel light source 20 to emit light will be described with reference to FIG. 3. The power source unit 40 includes a readout light power source unit 41 for applying a driving voltage to the readout light source 20A, and an erasing light power source unit 43 for applying a driving voltage to the erasing light source 20B. Switching elements 42 are provided between the readout light source 20A and readout light power source unit 41. Likewise, switching elements 44 are provided between the erasing light source 20B and erasing light power source unit 43. The switching operation of the switching elements 42 and 44 is controlled by a drive control unit 45. Thus, the operation of the readout light source 20A and erasing light source 20B is controlled by the drive control unit 45.

When readout light is to be emitted from the readout light source 20A, the switching elements 44 are sequentially switched ON in the scanning direction (direction of arrow Z). Then, a driving voltage is applied sequentially between the anode 22a and each of the linear cathodes 24b, and readout light is emitted sequentially from the EL layer 23a sandwithed between the anode 22a and each of the linear cathodes 24b.

Meanwhile, when erasing light is to be emitted from the erasing light source 20B, all the swtching elements are switched ON. Then, a driving voltage is applied between the anode 22b and each of the cathodes 24b, and erasing light is emitted from the region of the erasing light source 20B sandwitched by the anode 22b and each of the cathodes 24b. Here, when the erasing light is to be emitted, the drive control unit 45 controls the erasing light source 20B and readout light source 20A such that erasing light is emitted from the erasing light source 20B and readout light is emitted from the readout light source 20A. This ensures that image information remining on the image recording medium 10 is eliminated reliably.

Next, example operation of the image readout apparatus 1 will be described with reference to FIGS. 1 and 2. First, when reading out image information from the image recording medium 10, a driving voltage is applied to the readout light source 20A from the readout light power source unit 41 through control of the drive control unit 45, the linear readout light is sequentially irradiated on the image recording medium 10. Then, the image information is sequentially obtained by the signal obtaining unit 50 from the region of the image recording medium 10 where the readout light has been irradiated.

After the readout light has been irradiated, erasing light is irradiated on the image recording medium 10 to eliminate the image inforamtion remaining thereon. More specifically, a driving voltage is applied to the readout light source 20A and erasing light source 20B from the readout light power source unit 41 and erasing light power source unit 43 respectively to irradiate the readout light and erasing light on the image recording medium 10. Then, residual image information is eliminated from the image recording medium 10.

According to the present embodiment, the erasing light source 20B is provided to emit erasing light for erasing image information remining on the image recording medium 10 through the gaps between the electroluminescence elements. This allows the erasing light to be irradiated on the gap regions of the image recording medium 10 where readout light is not irradiated, after image information has been read out from the medium 10 by irradiating the readout light thereon. This ensures that image information remaining on the image recording medium 10 is eliminated reliably, thereby degradation in the image quality may be prevented. That is, when a panel light source, which is scan drived to sequentially emit linear light, is used as the readout light source, the readout light is not irradiated on certain regions of the image recording medium 10, unlike the case where a readout light source itself is scan moved. This causes a problem that some of the image information remains on the image recording medium without being read out. Here, the residual image remaining on the image recordining medium 10 is eliminated reliably by providing the erasing light source 20B and irradiating the erasining light on the regions where the readout light is not irradiated.

FIG. 4 is a schematic diagram of a second embodiment of the panel light source of the present invention. The panel light source 120 will be described with reference to FIG. 4. In the panel light source shown in FIG. 4, regions having identical structures to those of the panel light source 20 shown in FIG. 2 are given the same reference numerals and will not be elaborated upon further here.

The panel light source 120 shown in FIG. 4 has a focusing optics system 121 between the readout light source 20A and image recording medium 10. The focusing optics system 121 is constituted by, for example, a SLP (SELFOC lens plate) or the like. In particular, a focusing optics system having a greater depth of focus is used in order to irradiate the readout light onto the readout photoconductive layer 12 of the image recording medium 10. The readout light and erasing light emitted respectively from the readout light source 20A and erasing light source 20B are focused on the image recording medium 10 through the focusing optics system 121. This causes the readout light and erasing light emitted respectively from the readout light source 20A and erasing light source 20B to be focused and irradiated on the image recording medium 10. That is, the amount of light required for the readout light and erasing light may be obtained effectively.

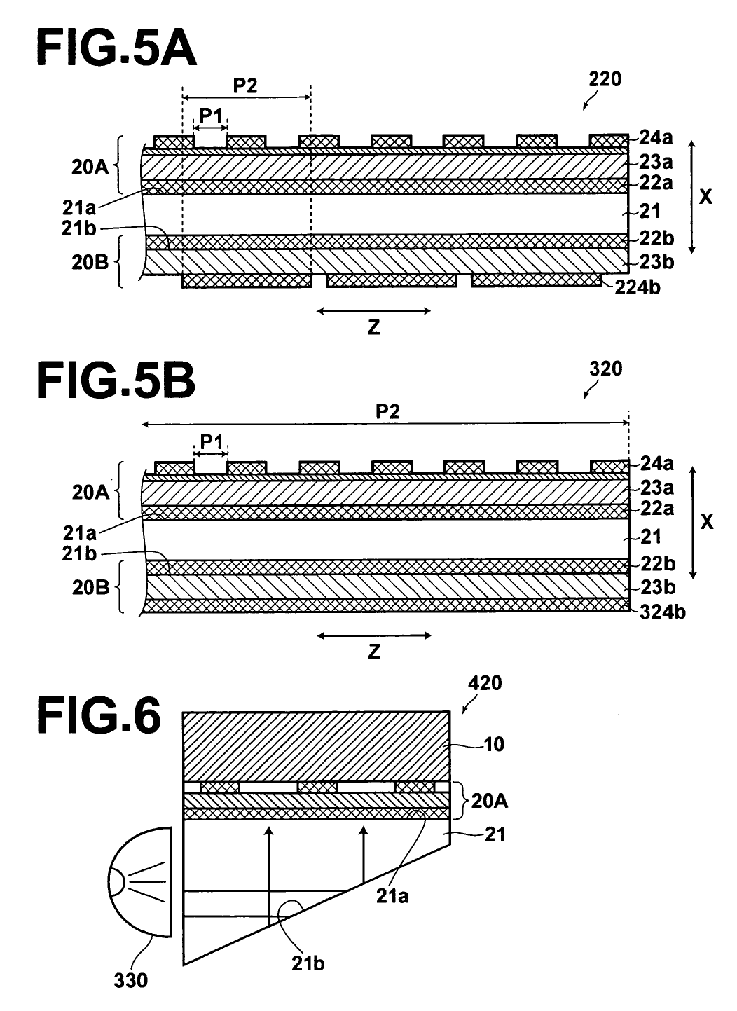

FIGS. 5A and 5B are schematic diagrams of a third embodiment of the panel light source of the image readout apparatus of the present invention. The panel light source 220 will be described with reference to FIG. 4. In the panel light source shown in FIGS. 5A and 5B, regions having identical structures to those of the panel light source 20 shown in FIG. 2 are given the same reference numerals and will not be elaborated upon further here.

The panel light source 220 shown in FIGS. 5A or 5B differs from the panel light source 20 shown in FIG. 2 in that it has a different electrode pattern for the cathodes 224b of the erasing light source 220B. That is, in the panel light source 220 shown in FIG. 5A, each of the cathodes 224b of the erasing light source 20B extends over a plurality of the gaps of the readout light source 20A. In addition, a plurality of EL elements of the erasing light source 20B is arranged such that each of the gaps between the EL elements of the erasing light source 20B is positioned at the place corresponding to the place where the EL element of the readout light source 20A locates. In the panel light source 320 shown in FIG. 5B, the cathode 324b of the erasing light source 20B is formed in a plate. That is, the erasing light is irradiated onto all of the gaps of the readout light source 20A from the erasing light source 20B constituted by a single plate EL element.

In this case also, the erasing light may be irradiated onto the gaps of the readout light source 20A when erasing image information remaining on the image recording medium 10, so that the image information remaining on the image recording medium 10 may be eliminated reliably, thereby degradation in the image quality may be prevented.

FIG. 6 is a schematic diagram of another embodiment of the erasing light source of the image readout apparatus of the present invention. The panel light source 330 will be described with reference to FIG. 6. In the panel light source 420 shown in FIG. 6, regions having identical structures to those of the panel light source 20 shown in FIG. 2 are given the same reference numerals and will not be elaborated upon further here.

In FIG. 6, the erasing light source 330 is constituted by a cold chathode ray tube, and the erasing light is emitted from the side of the transparent substrate 21. The readout light source 20A is formed on the first surface 21a, and a light guide plate for guiding the erasing light emitted from the side of the substrate 21 to the first surface 21a is formed on the second surface 21b of the transparent substrate 21.

In this case also, erasing light may be irradiated onto the gaps of the readout light source 20A when erasing image information remaining on the image recording medium 10, so that the image information remaining on the image recording medium 10 is eliminated reliably, thereby degradation in the image quality may be prevented.

It should be appreciated that the embodiments of the present invention are not limited to those described above. For example, in the image readout apparatus shown in FIG. 1, a solid-state detector is illustrated as an example of the image recording medium 10, but the panel light source 20 may also be applied to an image recording medium made of a storage phosphor sheet.

In each of the embodiments described above, an inorganic EL panel using inorganic EL material is illustrated as the panel light source 20. But the panel light source 20 may be a MPE (multiphoton emission) organic EL panel that uses a high voltage as in the inorganic EL panel.

Further, in each of the embodiments described above, the image readout apparatus 1 is structured such that the image recording medium 10 and readout light source 20A face with each other, but it may be structured such that the image recording medium 10 and erasing light source 20B face with each other.

What is claimed is:

1. An image readout apparatus for reading out image information recorded on an image recording medium by irradiating readout light thereon, the apparatus comprising:
a readout light source constituted by a plurality of electroluminescence elements arranged in stripes for irradiating linear light on the image recording medium; and
an erasing light source for emitting erasing light through gaps between the electroluminescence elements to erase image information recorded on the image recording medium.

2. The image readout apparatus according to claim 1, wherein the readout light source is constituted by electroluminescence elements provided on a first surface of a transparent substrate, and the erasing light source is constituted by electroluminescence elements provided on a second surface of the substrate.

3. The image readout apparatus according to claim 1, wherein the erasing light source is constituted by electroluminescence elements arranged at places corresponding to the gaps between the electroluminescence elements arranged in stripes.

4. The image readout apparatus according to claim 3, wherein the erasing light source is formed such that it overlaps with the region where the readout light source is formed.

5. The image readout apparatus according to claim 1, wherein a focusing optics system for focusing the readout light is disposed between the image recording medium and readout light source.

6. The image readout apparatus according to claim 1, wherein the erasing light source is constituted by a cold cathode ray tube.

7. The image readout apparatus according to claim 1, further comprising a drive control means for controlling the operation of the readout light source and erasing light source, the drive control means controlling the readout light source and erasing light source, when erasing image information recorded on the image recording medium, such that the erasing light is emitted from the erasing light source and the readout light is emitted from the readout light source.
